(19) United States
(12) Patent Application Publication
(10) Pub. No.: US 2014/0167635 A1
(43) Pub. Date: Jun. 19, 2014

(54) Method for Starting a High-Pressure Discharge Lamp

(71) Applicant: Joachim Mühlschlegel, Grobenzell (DE)

(72) Inventor: Joachim Mühlschlegel, Grobenzell (DE)

(21) Appl. No.: 13/825,710

(22) PCT Filed: Sep. 22, 2010
(86) PCT No.: PCT/EP2010/063954

§ 371 Date: Jun. 21, 2013

(51) Int. Cl. H05B 41/04

(52) U.S. Cl. CPC H05B 41/04
USPC 315/223

(57) ABSTRACT

A method for starting a high-pressure discharge lamp by means of a starter, having a starting capacitor, a starting switch and a starting transformer, wherein the method comprises the following temporally successive steps: charging the starting capacitor to a predetermined voltage; closing the starting switch; and opening the starting switch before the current through the starting switch reaches zero for the first time in terms of its fundamental component.

### TECHNICAL FIELD

The invention relates to a method for starting a high-pressure discharge lamp by means of a starter.

### BACKGROUND

The invention is based on a method for starting a high-pressure discharge lamp by means of a starter having a starting transformer according to the preamble to the main claim.

A starter of this kind and a starting method are known from DE 199 09 529 A1. The known starter has a starting transformer, a starting capacitor and a spark gap as a starting switch. The primary winding is connected in series with the starting capacitor and the spark gap. The secondary winding is connected in the current path of the high-pressure discharge lamp to be started. A charging voltage is applied parallel to the starting capacitor. If this exceeds the spark gap switching voltage, the spark gap is triggered and a short, high current surge is induced in the primary winding of the starting transformer, which is transformed upward and applied via the secondary winding to the high-pressure discharge lamp. If the primary current falls below a specific value, the discharge arc in the spark gap is extinguished and the spark gap switches off again. In this case, the on-time is not optimal since the spark gap cannot be actively switched off and continues to conduct until the starting current falls below a holding threshold causing the spark gap to switch off. The on-time is therefore significantly longer than the optimal on-time.

A starter with a controlled starting switch is known from DE 197 12 258 A1. This is controlled by a predetermined starting frequency in order to generate starting pulse packets to start the high-pressure discharge lamp. Therefore, the on-time is fixed and usually selected such that the switch is switched off in the phase in which the free-wheeling diode conducts parallel to the switch. The switching-off takes place at a time after the starting capacitor has reached its first negative voltage maximum. This keeps the losses on switching low. Here, the maximum starting pulse height is reached on the switching-on of the starting switch (switch-on starting pulse). However, the resulting starting pulse shape is not optimal for starting high-pressure discharge lamps.

### OBJECT

It is the object of the invention to disclose a method for starting a high-pressure discharge lamp by means of a starter, which generates a starting pulse shape which is improved compared to the prior art.

### SUMMARY

The object is achieved according to the invention by a method for starting a high-pressure discharge lamp by means of a starter having a starting capacitor, a starting switch and a starting transformer, characterized by the following temporally successive steps:
charging the starting capacitor to a predetermined voltage,
closing the starting switch,
opening the starting switch before the current through the starting switch reaches zero for the first time in terms of its fundamental component.

Here, the fundamental component should be considered to be the fundamental frequency of the starting switch current without higher-frequency vibrations. These high-frequency vibrations can result in the current through the starting switch briefly reaching zero before the fundamental component of the starting switch current reaches zero. According to the invention, the starting switch is actively switched off and at the same time the on-time is kept short enough for the starting switch to be switched off under current. This measure enables a higher starting voltage with a higher repeat accuracy to be achieved.

Preferably, the starting switch is opened at a switch-off time, which is dependent on the present voltage of the starting capacitor. This measure achieves a more simple control of the starting switch.

Particularly preferably, here, the switch-off time is within the voltage range of from 60% of the positive charging voltage of the starting capacitor up to 90% of the charging voltage of the starting capacitor achieved in the following negative voltage maximum. In this range, depending on the configuration of the circuit arrangement used and the lamp used and the cable lengths between the circuit arrangement and the lamp, the voltage generated on the opening of the switch can be higher than the voltage generated on the closing of the switch.

An advantageous range for the switch-off times for a specific circuit arrangement can be obtained during the development of the circuit arrangement by means of the following method:
varying the switch-off time within the large switch-off range defined above,
measuring the starting voltage at the high-pressure discharge lamp,
buffering the switch-off time with the highest starting voltage so far,
storing the switch-off time determined when the entire switch-off range has been passed through,
varying the switch-off time within the large above-defined switch-off range,
measuring the starting voltage at the high-pressure discharge lamp,
buffering a first switch-off time, which generates 80% of the highest starting voltage and which lies temporally before the switch-off time with the highest starting voltage,
buffering a second switch-off time, which generates 80% of the highest starting voltage and which lies temporally after the switch-off time with the highest starting voltage,
definition of the advantageous switch-off range between the first switch-off time and the second switch-off time.

This method can also be performed by the circuit arrangement during operation as long as the actual starting voltage or a variable correlating with the starting voltage can be measured. In this case, the measurement of an absolute starting voltage variable is not mandatorily necessary, it is sufficient for the height of the starting voltage to be measured relatively.

Preferably, the circuit arrangement generates a plurality of starting pulses during a starting phase by repeatedly closing and re-opening the switch.

Particularly preferably, in this case, the switch-off time is varied within the above-determined advantageous switch-off range. This enables differences in the starting voltage due to cables of different lengths and different lamp types to be compensated so that at least one starting pulse reaches the maximum starting pulse height.

In a preferred embodiment, the switch-off time is varied within the switch-off range until the high-pressure discharge lamp has started and this switch-off time is then stored in order to start with this switch-off time on the next starting phase.

The circuit arrangement for starting a high-pressure discharge lamp has a starting transformer with a primary and a secondary winding, wherein the secondary winding is connected to the lamp to be started and the primary winding is connected to a starting switch, wherein the starting switch can be controlled in order actively to switch off a current flowing through the primary winding of the starting transformer and the circuit arrangement performs the above method and varies the switch-off times of the switch within a predetermined range. This enables an optimal starting pulse to be achieved for all configurations of the circuit arrangement with different lamps and cable lengths.

Further advantageous developments and embodiments of the method according to the invention for starting a high-pressure discharge lamp may be derived from further dependent claims and from the following description.

### BRIEF DESCRIPTION OF THE DRAWINGS

Further advantages, features and details of the invention may be found in the following description of exemplary embodiments and with reference to the drawings in which the same or functionally equivalent elements are designated with identical reference characters. The drawings show:

FIG. 1 a circuit arrangement comprising a starter having a controlled switch, which is able to carry out the method according to the invention,

FIG. 2 a known starting pulse shape and the curves of relevant variables,

FIG. 3 a first starting pulse shape according to the invention and the curves of relevant variables generated by controlled switching-off of the starting switch,

FIG. 4a a second starting pulse shape according to the invention and the curves of relevant variables, which is characterized by the maximum switch-on time of the starting switch,

FIG. 4b a third starting pulse shape according to the invention and the curves of relevant variables, which is characterized by the minimum switch-on time of the starting switch,

FIG. 5 a graphical representation of the optimal range for the switch-off time of the starting switch.

### PREFERRED EMBODIMENT OF THE INVENTION

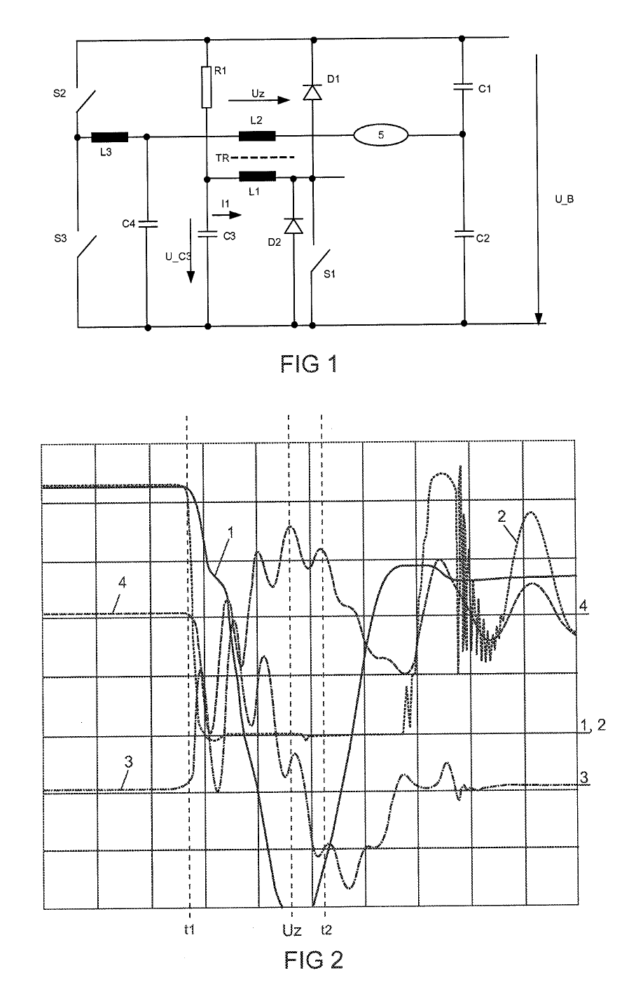

FIG. 1 shows a circuit arrangement which is known per se for the operation of high-pressure discharge lamps having a half-bridge with the series-connected half-bridge switches S2 and S3 with a series connection of a lamp inductor L3, the secondary winding L2 of a starting transformer TR and a high-pressure discharge lamp 5 being connected with the center point thereof.

The free end of the high-pressure discharge lamp 5 is connected with the interconnection point of a series connection of 2 coupling capacitors C1 and C2. The half-bridge is connected parallel to the series connection of the coupling capacitors. The supply voltage U_B (in this exemplary embodiment 425V) is applied to this parallel connection. At the primary winding L1, a starting capacitor C3 and a starting switch S1 are connected in series with a parallel-connected free-wheeling diode D2 forming the primary circuit. The anode of the free-wheeling diode and a connection of the starting capacitor C3 are connected with the reference potential of the supply voltage U_B. A charging resistor R1 for charging the starting capacitor C3 is connected between the other connection of the starting capacitor C3 and the supply potential of the supply voltage U_B.

This resistor charges the starting capacitor C3 until the voltage U_C3 applied thereto exceeds a predetermined charging voltage. When this is the case, the starting switch S1 is switched on at the time t1, i.e. becomes conductive, as shown in FIG. 2. This causes a circular current to start to flow through the components C3, L1 and S1/D2 and the circular current is transformed by the starting transformer TR on the secondary side into a starting voltage Uz. At a fixed time t2,the starting switch is switched off again. In the starting pulse shape according to the prior art shown here, the on-time of the starting switch is t2−t1=2.6 \μs. Channel 1 shows the voltage at the starting capacitor C3. Channel 2 shows the voltage at the starting switch S1, channel 3 the current i₁ through the primary winding L1 of the starting transformer TR. Finally, channel 4 shows the starting voltage Uz, which here has a maximum at the switch-off starting pulse of about 3 kV.

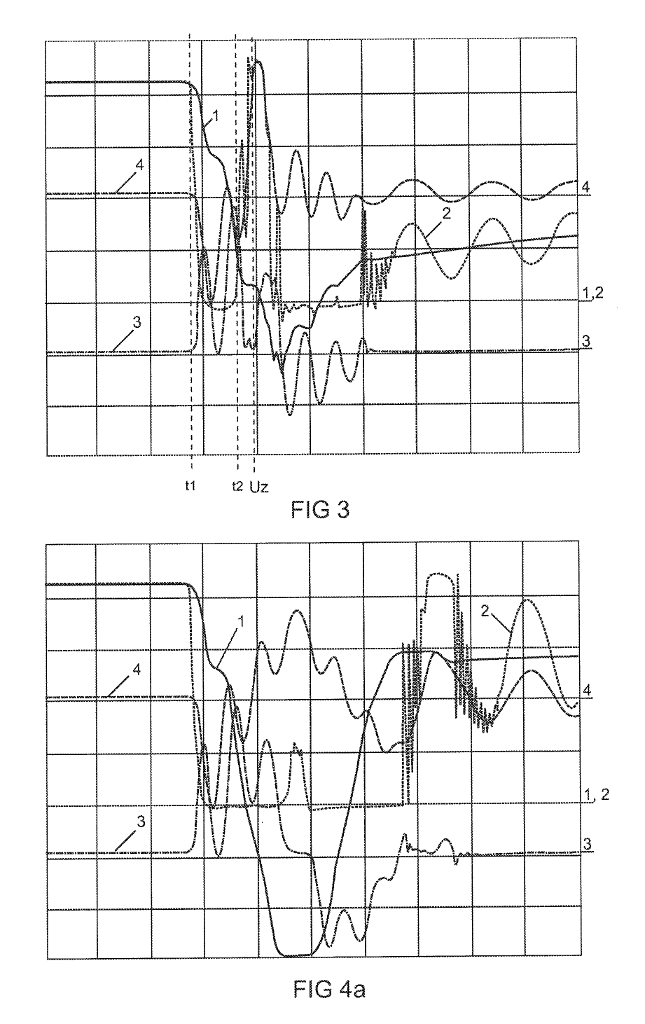

FIG. 3 shows a starting pulse shape generated with the method according to the invention and the curves of relevant variables. Here the on-time of the starting switch is t2−t1=0.8 \μs. The starting voltage on the switch-off starting pulse is here 5.2 kV.

According to the invention, in this case, the starting switch is switched off before the starting capacitor has reached its maximum negative charge, i.e. before the starting switch current reaches zero in terms of its fundamental component (the high-frequency vibration is not taken into account here). The optimal switch-off time (see FIG. 5) lies within the time range in which, on its first discharge, the starting capacitor C3 covers the voltage range of from +60% of the charging voltage up to the attainment of 90% of the charging voltage of the following negative voltage maximum (−90%), which would be reached without active switching-off of the starting switch (see FIG. 2). In this case, the charging voltage is the voltage applied to the starting switch before the switching-on of the starting switch.

If the optimal switch-off time of the starting switch is selected, the maximum starting pulse height is reached on the switching-off of the starting switch. This is referred to as a switch-off starting pulse. Here, the value of the starting voltage is higher than the starting voltage on the switching-on of the switch, which is designated the switch-on starting pulse.

An overall particularly effective starting pulse is in particular also achieved in that an equally high or higher switch-off starting pulse is generated which directly follows the switch-on starting pulse in the starting voltage curve.

In this example, the switch-on starting pulse is about 4 kV and, as described above, the switch-off starting pulse is about 5.2 kV.

Here, the optimal time for the switching-off depends on the lamp cable length and on the cable capacity and inductivity. The lamp cable length, cable capacity and inductivity vary according to the application. In order to always achieve the optimal switch-off time for each lamp cable length, the on-time of the starting switch is varied during the starting phase of the electronic ballast in a time range in such a way that the optimal duration is covered for each possible configuration in the application.

This method can in particular be performed particularly advantageously with a microcontroller. This can vary the switch-off time during the starting phase in an advantageous range in order to be able to generate a starting pulse of optimal height in each case. If the circuit arrangement is set up to measure the starting voltage, either directly or indirectly (for example via the current in the primary circuit of the starting device), the switch-off time generated by the highest starting pulse can be stored in order to contest future starting phases with this switch-off time. The method can be repeated as required or at regular intervals.

If the circuit arrangement is not set up to measure the height of the starting pulse, the microcontroller can store the switch-off time at which the high-pressure discharge lamp started.

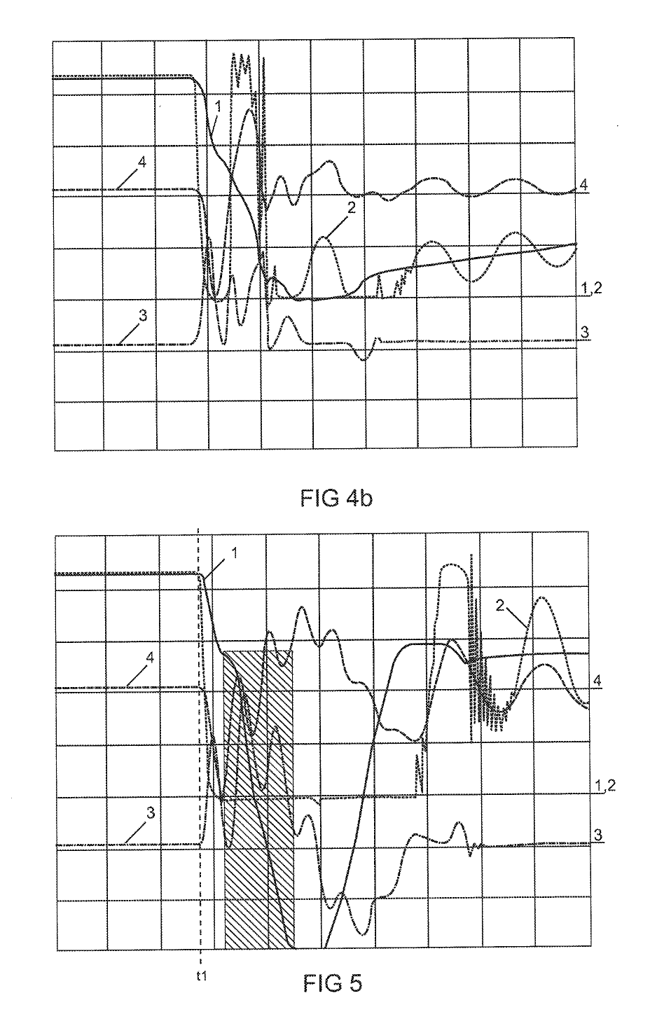

FIG. 4a shows a starting pulse generated with the method according to the invention and the curves of relevant variables with an on-time of the starting switch lying at the upper limit of the on-time according to the invention. The designation the relevant variables is the same as in FIG. 3. The switch-on starting pulse is here about 4 kV, the switch-off starting pulse is about 3.6 kV.

FIG. 4b shows the situation with an on-time of the starting switch lying at the lower limit of the on-time according to the invention. The designation of the relevant variables is the same as in FIG. 3. The switch-on starting pulse is here about 4 kV, the switch-off starting pulse is about 3.3 kV.

FIG. 5 shows the curves of FIG. 2 with a graphical depiction of the optimal switch-off time according to the invention of the starting switch S1. In this case, the starting switch is switched on at the time t1.

1. A method for starting a high-pressure discharge lamp by means of a starter, having a starting capacitor, a starting switch and a starting transformer, wherein the method comprises the following temporally successive steps:
charging the starting capacitor to a predetermined voltage;
closing the starting switch; and
opening the starting switch before the current through the starting switch reaches zero for the first time in terms of its fundamental component.

2. The method as claimed in claim 1, wherein the starting switch is opened at a switch-off time dependent upon the current voltage of the starting capacitor.

3. The method as claimed in claim 2, wherein, during a starting phase, the switch is closed and opened several times in sequence in order to generate a plurality of starting pulses.

4. The method as claimed in claim 2, wherein the switch-off time of the starting pulses lies within a switch-off range defined by a voltage range of from 60% of the positive charging voltage of the starting capacitor up to 90% of the voltage of the starting capacitor achieved in the following negative voltage maximum.

5. The method as claimed in claim 3, wherein the switch-off time varies within the switch-off range.

6. The method as claimed in claim 5, further comprising the following steps:
variation of the switch-off time within the switch-off range;
measuring the starting voltage at the high-pressure discharge lamp or another variable correlated therewith;
buffering the switch-off time with the highest starting voltage so far; and
storing the switch-off time established when the entire switch-off range has been passed through.

7. The method as claimed in claim 5, wherein the switch-off time is varied within the switch-off range until the high-pressure discharge lamp has started and this switch-off time is then stored permanently.

8. A circuit arrangement for starting a high-pressure discharge lamp comprising a starting transformer having a primary and a secondary winding, wherein the secondary winding is connected to the lamp to be started and the primary winding is connected to a starting switch, wherein the starting switch can be controlled in order actively to switch off a current flowing through the primary winding of the starting transformer and the circuit arrangement executes the method as claimed in claim 6.

9. The circuit arrangement as claimed in claim 8, wherein the circuit arrangement is configured to generate starting pulses by switching off the switch at switch-off times lying in a switch-off range in which the maximum voltages of the generated starting pulses lie between 80% to 100% of the maximum voltage of the starting pulse generated with said switch-off time.

10. The circuit arrangement as claimed in claim 9, wherein the circuit arrangement is configured to generate a plurality of starting pulses with different switch-off times within said switch-off range.

11. The method as claimed in claim 2, wherein the switch-off time of the starting pulses lies within a switch-off range defined by a voltage range of from 60% of the positive charging voltage of the starting capacitor up to 90% of the voltage of the starting capacitor achieved in the following negative voltage maximum.
